(19) United States
(12) Patent Application Publication
(10) Pub. No.: US 2010/0007586 A1
(43) Pub. Date: Jan. 14, 2010

(54) PLASMA DISPLAY PANEL

(75) Inventors: Jun-Yong Park, Suwon-si (KR); Won-Hee Jeong, Suwon-si (KR); Joo-Sick Jung, Suwon-si (KR); Su-Bin Song, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/412,250

(22) Filed: Mar. 26, 2009

(30) Foreign Application Priority Data
Jul. 14, 2008 (KR) 10-2008-0068340

(51) Int. Cl. G09G 3/28

(52) U.S. Cl. 345/71; 345/60

(57) ABSTRACT

A plasma display panel (PDP) is disclosed. In one embodiment, the PDP includes: i) first and second substrates facing each other, ii) a plurality of first barrier ribs formed between the first and second substrates and configured to define a plurality of discharge cells and iii) a plurality of second barrier ribs dividing each of the discharge cells into a first sub-discharge cell and a second sub-discharge cell, wherein a phosphor layer is formed in the first sub-discharge cells and is not formed in the second sub-discharge cells. According to one embodiment, the PDP has high driving efficiency obtained by improving an address voltage margin, and high image quality obtained by removing noise brightness caused by discharge light resulting from an address discharge, and is suitable for an image display with high efficiency and high resolution.

### CROSS-REFERENCE TO RELATED PATENT APPLICATION

This application claims the benefit of Korean Patent Application No. 10-2008-0068340, filed on Jul. 14, 2008, in the Korean Intellectual Property Office, the disclosure of which is incorporated herein in its entirety by reference.

### BACKGROUND OF THE INVENTION

1. Field of the Invention

The present invention relates to a plasma display panel (PDP), and more particularly, to a PDP which has high driving efficiency, and high image quality, and is suitable for an image display with high efficiency and high resolution.

2. Description of the Related Technology

In a plasma display panel (PDP), a plurality of discharge cells arranged in a matrix are interposed between a front substrate and a rear substrate. Scan electrodes and sustain electrodes, generating a mutual discharge, are disposed on the front substrate. A plurality of address electrodes are disposed on the rear substrate. The front substrate and the rear substrate are bonded so as to face each other. A predetermined discharge gas is injected between the front and rear substrates. Phosphors coated in the discharge cells are excited by applying a predetermined discharge pulse between discharge electrodes (that is, the scan and sustain electrodes) so as to generate visible light, thereby realizing a desired image.

### SUMMARY OF CERTAIN INVENTIVE ASPECTS

One aspect of the present invention is a plasma display panel (PDP) having high driving efficiency obtained by improving an address voltage margin.

Another aspect of the present invention is a PDP having high quality and high contrast obtained by removing noise brightness, such as discharge light generated when an address discharge occurs or background light.

Another aspect of the present invention is a PDP suitable for an image display with high efficiency and high resolution.

Another aspect of the present invention is a PDP comprising: i) a front substrate and rear substrate that face each other, ii) a plurality of first barrier ribs that are disposed between the front substrate and the rear substrate to define a plurality of unit cells, iii) a plurality of units each comprising a scan electrode and a sustain electrode that cause a display discharge in the unit cells, iv) a plurality of second barrier ribs that divide each of the unit cells into a main discharge space and an auxiliary discharge space, wherein the second barrier rib in each unit cell is formed closer to the scan electrode than the sustain electrode, v) address electrodes that perform an address discharge together with the scan electrodes, and extend in a direction perpendicular to the direction of the scan electrodes, vi) floating electrodes disposed between the scan electrodes and the address electrode and vii) a phosphor layer formed in the main discharge space.

The PDP may further comprise a dielectric layer to cover the units comprising the scan electrodes and the sustain electrodes, wherein the floating electrodes are buried in the dielectric layer.

At least a portion of each of the floating electrodes may be formed above at least a portion of the corresponding auxiliary discharge space such that the at least a portion of the corresponding auxiliary discharge space and the at least a portion of the floating electrode overlap each other.

The floating electrode may be formed between the scan electrode of a first of the unit cells and the sustain electrode of a second of the unit cells, wherein the first unit cell and the second unit cell are adjacent to each other.

Each of the second barrier ribs may be disposed to face the corresponding scan electrode with a discharge gap therebetween.

The height of the second barrier ribs may be less than the height of the first barrier ribs.

The phosphor layer may not be formed in the auxiliary discharge space.

The PDP may further comprise a protective layer covering the units each comprising a scan electrode and a sustain electrode.

The PDP may further comprise an electron emission material layer formed in the auxiliary discharge space.

The PDP may further comprise an electron emission material layer formed on a top surface of the second barrier ribs adjacent to the scan electrode.

Another aspect of the present invention is a PDP comprising: i) a front substrate and a rear substrate that face each other, ii) a plurality of first barrier ribs that are disposed between the front substrate and the rear substrate to define a plurality of unit cells, iii) a plurality of units each comprising a scan electrode and a sustain electrode that cause a mutual discharge in the unit cells, iv) a dielectric layer covering the units comprising the scan electrodes and the sustain electrodes and having a groove which is formed in a position at least corresponding to the scan electrode, v) a plurality of second barrier ribs that divide each of the unit cells into a main discharge space and an auxiliary discharge space, wherein the second barrier rib in each unit cell is formed closer to the scan electrode than the sustain electrode, vi) address electrodes that perform an address discharge together with the scan electrodes, and extend in a direction perpendicular to the direction of the scan electrodes and vii) floating electrodes disposed between the scan electrodes and the address electrodes.

The PDP may further comprise a dielectric layer to cover the units comprising the scan electrodes and the sustain electrodes, wherein the floating electrodes are buried in the dielectric layer.

At least a portion of each of the floating electrodes may be formed above at least a portion of the corresponding auxiliary discharge space such that the at least a portion of the corresponding auxiliary discharge space and the at least a portion of the floating electrode overlap each other.

The floating electrode may be formed between the scan electrode of a first of the unit cells and the sustain electrode of a second of the unit cells, wherein the first unit cell and the second unit cell are adjacent to each other.

Each of the second barrier ribs may be disposed to face the corresponding scan electrode with a discharge gap therebetween.

The height of the first barrier ribs and the height of the second barrier ribs may be equal.

The phosphor layer may not be formed in the auxiliary discharge space.

The PDP may further comprise a protective layer covering the units comprising the scan electrodes and the sustain electrodes.

The PDP may further comprise an electron emission material layer formed in the auxiliary discharge space.

The PDP may further comprise an electron emission material layer formed on a top surface of the second barrier rib adjacent to the scan electrode.

Another aspect of the invention is a plasma display panel (PDP) comprising: i) a front substrate and rear substrate that face each other, ii) a plurality of first barrier ribs disposed between the front substrate and the rear substrate and configured to define a plurality of unit cells, iii) a plurality of units each comprising a scan electrode and a sustain electrode which are configured to generate a display discharge in the unit cells, iv) a plurality of second barrier ribs that divide each of the unit cells into a main discharge space and an auxiliary discharge space, wherein the second barrier rib in each unit cell is formed closer to the scan electrode than the sustain electrode, v) a plurality of address electrodes configured to perform an address discharge together with the scan electrodes, and extend in a direction substantially perpendicular to the direction of the scan electrodes, vi) a plurality of floating electrodes disposed between the scan electrodes and the address electrodes and viii) a phosphor layer formed in the main discharge space.

The PDP may further comprise a dielectric layer covering the plurality of units and the floating electrodes. In the above PDP, at least a first portion of each of the floating electrodes may be formed above at least a second portion of the corresponding auxiliary discharge space such that the at least first portion and the at least second portion overlap each other. In the above PDP, at least one of the floating electrodes may be formed between the scan electrode of a first unit cell and the sustain electrode of a second unit cell, which is adjacent to the first unit cell. In the above PDP, each of the second barrier ribs may be disposed to face the corresponding scan electrode with a discharge gap defined therebetween. In the above PDP, the height of the second barrier ribs may be less than the height of the first barrier ribs. In the above PDP, the phosphor layer may not be formed in the auxiliary discharge space. The PDP may further comprise an electron emission material layer formed in the auxiliary discharge space or on a top surface of the second barrier ribs adjacent to the scan electrodes.

Another aspect of the invention is a PDP comprising: i) a front substrate and a rear substrate that face each other, ii) a plurality of first barrier ribs disposed between the front substrate and the rear substrate and configured to define a plurality of unit cells, iii) a plurality of units each comprising a scan electrode and a sustain electrode which are configured to generate a mutual discharge in the unit cells, iv) a dielectric layer covering the plurality of units, wherein a groove is formed in a position at least corresponding to the scan electrodes, v) a plurality of second barrier ribs that divide each of the unit cells into a main discharge space and an auxiliary discharge space, wherein the second barrier rib in each unit cell is formed closer to the scan electrode than the sustain electrode, vi) a plurality of address electrodes configured to perform an address discharge together with the scan electrodes, and extend in a direction substantially perpendicular to the direction of the scan electrodes and vii) a plurality of floating electrodes disposed between the scan electrodes and the address electrodes.

The PDP may further comprise a dielectric layer covering the plurality of units and the floating electrodes. In the above PDP, at least a first portion of each of the floating electrodes may be formed above at least a second portion of the corresponding auxiliary discharge space such that the at least first portion and the at least second portion overlap each other. In the above PDP, the floating electrode may be formed between the scan electrode of a first unit cell and the sustain electrode of a second unit cell, which is adjacent to the first unit cell. In the above PDP, each of the second barrier ribs may be disposed to face the corresponding scan electrode with a discharge gap defined therebetween. In the above PDP, the height of the first barrier ribs and the height of the second barrier ribs may be substantially the same. In the above PDP, the phosphor layer may not be formed in the auxiliary discharge space. The PDP may further comprise an electron emission material layer formed in the auxiliary discharge space or on a top surface of the second barrier rib adjacent to the scan electrodes.

Still another aspect of the invention is a plasma display panel (PDP) comprising: i) first and second substrates facing each other, ii) a plurality of first barrier ribs located between the first and second substrates and configured to define a plurality of discharge cells and iii) a plurality of second barrier ribs dividing each of the discharge cells into a first sub-discharge cell and a second sub-discharge cell, wherein a phosphor layer is formed in the first sub-discharge cells and is not formed in the second sub-discharge cells.

In the above PDP, a passage may be defined between each of the first sub-discharge cells and each of the second sub-discharge cells, and wherein residual particles after an address discharge may be configured to flow from the second sub-discharge cells into the first sub-discharge cells via the passage. The PDP may further comprise: a plurality of scan electrodes and a plurality of sustain electrodes, a protective layer contacting at least one of the first and second barrier ribs, a plurality of floating electrodes located between the scan electrodes and the protective layer, wherein each of the floating electrodes is configured to provide a uniform electrical field in each of the second sub-discharge cells and a dielectric layer covering the plurality of scan, sustain and floating electrodes. The PDP may further comprise an electron emission material layer formed in each of the second sub-discharge cells on a top surface of the second barrier ribs adjacent to the scan electrodes.

### BRIEF DESCRIPTION OF THE DRAWINGS

Embodiments of the present invention will be described with reference to the attached drawings.

FIG. 1 is an exploded perspective view of a plasma display panel (PDP) according to a first embodiment of the present invention.

FIG. 2 is a vertical sectional view taken along line II-II in FIG. 1.

FIG. 3 is a perspective view illustrating the arrangement of some of the components illustrated in FIG. 1.

FIG. 4 is a vertical cross-sectional view of a PDP according to a second embodiment of the present invention.

FIG. 5 is a vertical cross-sectional view of a PDP according to a third embodiment of the present invention.

FIG. 6 is an exploded perspective view of a PDP according to a fourth embodiment of the present invention.

FIG. 7 is a vertical sectional view taken along line VII-VII in FIG. 6.

### DETAILED DESCRIPTION OF CERTAIN INVENTIVE EMBODIMENTS

Generally, in order to realize gradation of an image, PDPs perform a time-division operation by dividing one frame into several sub-fields having different light emissions. Each of the sub-fields is divided into a reset period to uniformly cause a discharge, an address period to select a discharge cell, and a sustain period to realize gradation of an image according to the number of discharges. In the address period, a kind of auxiliary discharge is generated between an address electrode and a scan electrode and a wall voltage is formed in the selected discharge cell so as to form a desirable environment for a sustain discharge.

In general, the address period requires a higher voltage than that required for a sustain discharge. Therefore, a low input voltage, that is, a low address voltage, to perform a smooth addressing operation and ensuring a high voltage margin are generally used to improve the operation efficiency and discharge stability of a PDP. In addition, as PDPs are developed to full-HD resolution levels, the number of discharge cells required substantially increases and thus the number of address electrodes allotted to each of the discharge cells also increases. Therefore, a circuit unit is usually desirable to be designed to cope with high consumption power. Due to these reasons, high operation efficiency is generally desirable to operate with low electric power. In addition, a high xenon (Xe) display using a high partial pressure of xenon (Xe) in the discharge gas injected inside the PDP is advantageous for high luminous efficiency but requires a relatively high address voltage for initiating a discharge. Thus, a sufficient address voltage margin should be obtained to realize a highly efficient display.

Embodiments of the present invention will now be described more fully with reference to the accompanying drawings, in which exemplary embodiments of the invention are shown.

### First Embodiment

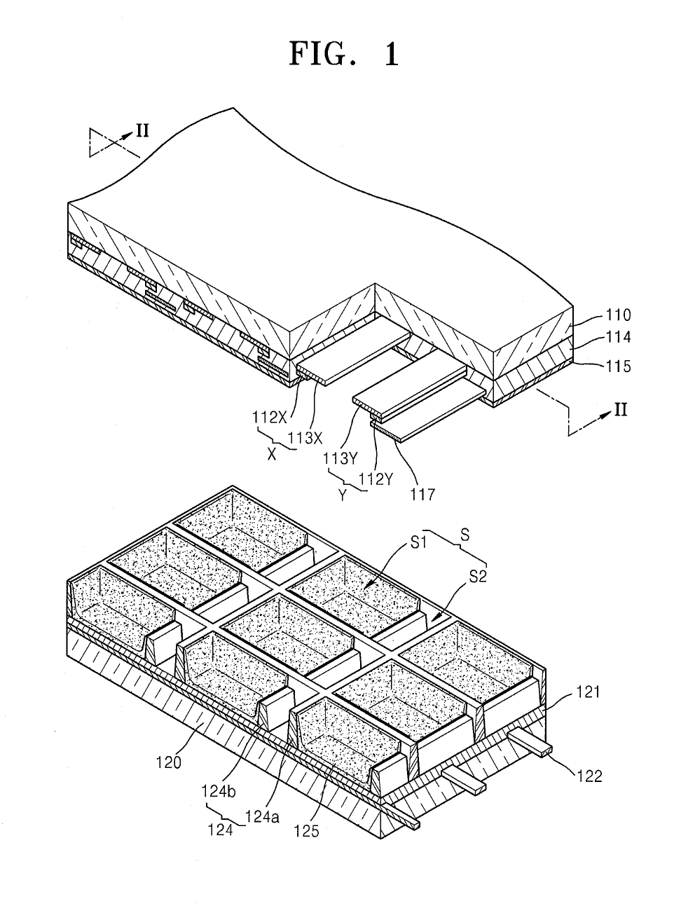

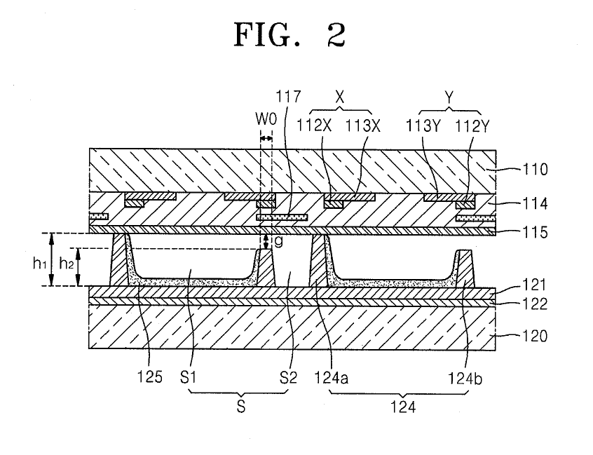

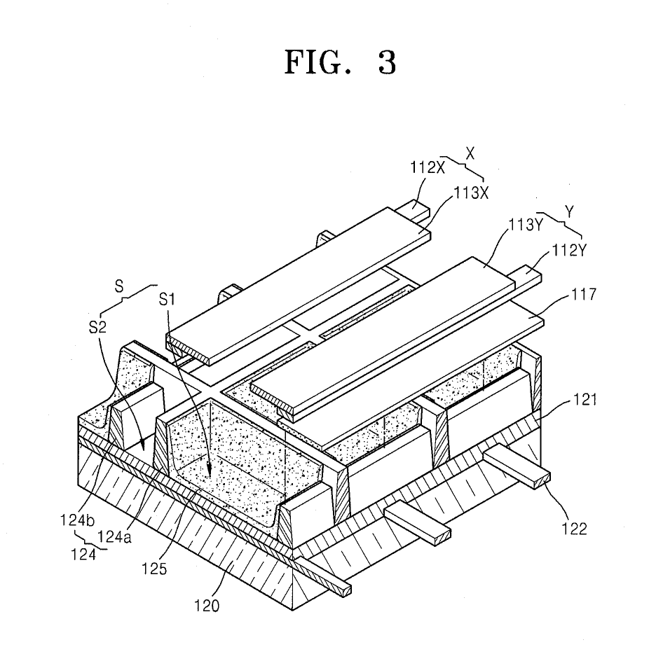

FIG. 1 is an exploded perspective view of a plasma display panel (PDP) according to a first embodiment of the present invention, FIG. 2 is a vertical sectional view taken along line II-II in FIG. 1, and FIG. 3 is a perspective view illustrating the arrangement of some of the components illustrated in FIG. 1.

The PDP of FIG. 1 includes a front substrate 110, a rear substrate 120 which is separated from and faces the front substrate 110, and a plurality of barrier ribs 124 dividing a space between the front substrate 110 and the rear substrate 120 into a plurality of unit cells S.

The unit cell S is a minimum light-emitting unit in which a pair of sustain electrodes X and Y cause a mutual display discharge and in which an address electrode 122 is extended to cross the pair of sustain electrodes X and Y. Further, the unit cell S is defined by the barrier rib 124, thereby realizing a predetermined display. Each unit cell S constitutes an independent light emitting area.

The pair of sustain electrodes X and Y includes a sustain electrode X and a scan electrode Y which perform a display discharge in pairs. The sustain electrodes X and Y respectively include bus electrodes 112X and 112Y and transparent electrodes 113X and 113Y. The bus electrodes 112X and 112Y form a power supply line. The transparent electrodes 113X and 113Y are formed of an optically transparent material, electrically contacting the bus electrodes 112X and 112Y, and extend toward the inside of each unit cell S in a width-wise direction.

In addition, the pair of sustain electrodes X and Y may be covered by a dielectric layer 114 such that the pair of sustain electrodes X and Y are not directly exposed to a discharge environment, and thus are protected from direct collisions with charged particles participating in a discharge. The dielectric layer 114 may be covered and protected by a protective layer 115 formed of, for example, an MgO thin film. The protective layer 115 may induce emission of secondary electrons and thereby facilitate a discharge.

Floating electrodes 117 may be further formed in the dielectric layer 114, and will be described in detail later.

The address electrode 122 is disposed on the rear substrate 120. The address electrode 122 performs an address discharge together with the scan electrode Y. In each unit cell S, the address electrode 122 is disposed in such a manner that the address electrode 122 is substantially perpendicular to the scan electrode Y. Herein, the address discharge is a kind of auxiliary discharge which supports a display discharge by accumulating priming particles in each unit cell S before a display discharge occurs. A discharge voltage applied between the scan electrode Y and the address electrode 122 can be focused in an area that is in the vicinity of a discharge gap g through the dielectric layer 114 covering the scan electrode Y and the barrier ribs 124 on the address electrode 122. Therefore, an initial discharge may occur through the discharge gap g which provides a shortest discharge path.

In one embodiment, the address electrodes 122 may be covered by a dielectric layer 121 on the rear substrate 120, and the barrier ribs 124 are formed on a plane surface of the dielectric layer 121. The barrier ribs 124 define a plurality of main discharge space S1 (or a first sub-discharge cell) and a plurality of auxiliary discharge space S2 (or a second sub-discharge cell), which are adjacent to the main discharge spaces S1, between the front substrate 110 and the rear substrate 120. More specifically, each of the barrier ribs 124 includes a first barrier rib 124a and a second barrier rib 124b. The first barrier rib 124a has a first height h1 which defines a space between the front substrate 110 and the real substrate 120 into the plurality of unit cells S, wherein a dotted line in FIG. 3 denotes the first barrier rib 124a. The second barrier rib 124b has a second height h2 which divides each unit cell S into a main discharge space S1 and an auxiliary discharge space S2. Such division of a discharge space into the main discharge space S1 and the auxiliary discharge space S2 may be made according to their discharge volumes for convenience of understanding. However, functions of the main discharge space S1 and the auxiliary discharge space S2 are not completely different from each other. For example, a display discharge can occur in the form of a long gap in the auxiliary discharge space S2, in addition to in the main discharge space S1.

The first barrier ribs 124a may be formed to the first height h1 so that unit cells S are substantially sealed to prevent optical and electrical cross-talk between adjacent unit cells S. The term “seal” does not mean that the unit cell S is hermetically sealed, and a gap having a minute size under a tolerance limit may exist on the first barrier rib 124a.

The second height h2 of the second barrier ribs 124b may be less than the first height h1 of the first barrier ribs 124a, thereby maintaining a predetermined discharge gap g and providing a flow pathway for priming particles formed as a result of the address discharge. Therefore, priming particles formed in the auxiliary discharge space S2 are allowed to flow into the main discharge space S1. Thus, the priming particles formed in the auxiliary discharge space S2 as a result of the address discharge are easily diffused to the main discharge space S1 along the flow pathway formed on the second barrier ribs 124b so as to participate in the display discharge.

In addition, the address voltage applied between the scan electrode Y and the address electrode 122 may be more activated in the auxiliary discharge space S2 than in the main discharge space S1 screened by a phosphor layer 125. In this regard, the auxiliary discharge space S2 may be formed to have a volume such that a sufficient volume of discharge gas can be contained therein so as to supply sufficient priming particles through the address discharge. For example, in each unit cell S, the location of the second barrier rib 124b can be adjusted to increase or decrease the volume of the auxiliary discharge space S2.

In addition, the address discharge can be initiated along the discharge gap g via a top surface of the second barrier rib 124b facing the scan electrode Y as a facing discharge surface. Herein, the scan electrode Y and the second barrier rib 124b may be aligned with respect to each other to reduce a discharge path. In particular, the scan electrode Y and the second barrier rib 124b may partially overlap each other to have a width WO (see FIG. 2).

The address discharge usually occurs in the auxiliary discharge space S2 and provides priming particles which are to participate in a display discharge. That is, the address discharge itself is not related to a display emission. When a discharge light is generated during the address discharge and leaks outside together with a display emission, noise brightness that appears as a haze occurs adjacent to an emission pixel and thus, the clarity of a display can be reduced to a low level. To prevent such problems, the discharge light generated in the auxiliary discharge space S2 can be blocked by forming black stripes on the auxiliary discharge space S2. However, formation of such black stripes is not strictly necessary since the bus electrode 112Y, which constitutes the scan electrode Y is, in general, formed of a metallic conductive material and thus the bus electrode 112Y itself can block light.

According to one embodiment of the present invention, the main discharge space S1 for a display discharge and the auxiliary discharge space S2 for an address discharge are separated from each other and a technical means which can block the discharge light can be easily designed. For example, a black stripe can be selectively disposed. However, in terms of a typical PDP, a display discharge and an address discharge occur at the same space, and thus, a discharge light cannot be blocked and the display quality is decreased. Specifically, a visible light generated by a phosphor activated by the address discharge forms a background light and a contrast effect may be degraded. However, according to one embodiment of the present invention, the phosphor is structurally isolated from the auxiliary discharge space S2 in which the address discharge primarily occurs. Therefore, the background light generated when the phosphor emits light during the address discharge can be substantially removed and high quality display having high contrast can be realized.

The fluorescence layer 125 is formed on inner walls of the main discharge space S1. For example, the fluorescence layer 125 can be formed on side walls of the first and second barrier ribs 124a and 124b which contact the main discharge space S1 and on a portion of the dielectric layer 121 between the first and second barrier ribs 124a and 124b. The fluorescence layer 125 can mutually react with ultraviolet light generated as a result of the display discharge to form visible light of various colors. For example, R, G, and B phosphors which realize different colors from each other are coated on the inside of the main discharge space S1, and thus, the main discharge space S1 or the unit cell S is defined as a R sub pixel, a G sub pixel, or B sub pixel.

The fluorescence layer 125 may not be formed in the auxiliary discharge space S1. Different phosphors having different kinds of materials have different electrical properties and can affect a discharge environment to a large degree. For example, a zinc silicate-based G phosphor, such as Zn₂SiO₄:Mn is inclined to have a negative (−) surface potential, on the other hand, R and B phosphors, such as Y(V,P)O₄:Eu or BAM:Eu, are inclined to have positive (+) surface potential. In one embodiment, to form a uniform discharge environment by preventing phosphor discharge interference, the phosphors are isolated from the pathway of the address discharge, which is why the phosphor is not coated in the auxiliary discharge space S2.

In a typical PDP, phosphor is directly exposed to an address discharge, and thus even when the same address voltage is applied, a voltage inside the discharge space may vary according to the electrical properties of the phosphor. That is, a G phosphor which tends to be negatively (−) charged reduces the address voltage, and on the other hand, R and B phosphors which tend to be positively (+) charged increase the address voltage. Therefore, although the same address voltage is applied to G, R, and B phosphors, voltages in discharge spaces having G, R, and B phosphors may differ from each other, and thus, an address voltage margin is decreased.

A display discharge primarily occurs in the main discharge space S1 which is separated from the auxiliary discharge space S2. The address discharge primarily occurs in the auxiliary discharge space S2. Further, phosphor is not formed in the space S2. When the main discharge space S1 is spaciously separated from the auxiliary discharge space S2, an address voltage applied from the outside can be uniformly provided to all of the auxiliary discharge spaces S2 according to unique electrical properties of phosphor, and thus, the address voltage margin can be significantly increased. In addition, comparing to typical PDPs, the same pre-discharge effect can be obtained using only a low address voltage, and when the same address voltage is applied, more priming particles can be accumulated and the subsequent display discharge can have high discharge intensity.

A discharge gas as a source gas for ultraviolet light is provided to the unit cell S including the main discharge space S1 and the auxiliary discharge space S2. The discharge gas can be a multiatomic gas including, for example, Xe, Kr, He, and Ne in a predetermined volume ratio, which can emit ultraviolet ray through discharge excitation. Generally, when the partial pressure of Xe in the multiatomic gas is high, that is, a high-Xe discharge gas is used, high emission efficiency can be obtained. However, the high-Xe discharge gas cannot be practically applied or has limited applications because it typically requires a large amount of operation consumption power due to high discharge initial voltage, and a circuit that can cope with high power. According to one embodiment of the present invention providing a high address voltage, sufficient priming particles can be obtained to ignite a discharge. Therefore, high-Xe PDP can be realized and emission efficiency can be significantly improved.

In the PDP according to one embodiment of the present embodiment, the floating electrodes 117 are formed in the dielectric layer 114 to form a uniform electric field and minimize an increase in ineffective power consumption. In particular, in the PDP according to one embodiment of the present embodiment, a uniform electric field can be formed in the auxiliary discharge spaces S2 in order to stably generate a discharge even at a low address voltage. To form the uniform electric field in the auxiliary discharge spaces S2, the greater the length of the scan electrode Y disposed above the auxiliary discharge space S2, the better. However, if the length of the bus electrode 112Y of the scan electrode Y is increased, a capacitance between the scan electrode Y and the sustain electrode X of the adjacent unit cell S is increased, resulting in an increase in ineffective power consumption and occurrence of crosstalk. To overcome these problems, in one embodiment of the present invention, the floating electrodes 117 are further formed in the dielectric layer 114 so that the increase in ineffective power consumption is minimized and a uniform electric field in the auxiliary discharge spaces S2 is formed.

The floating electrodes 117 are buried in the dielectric layer 114, and may be formed of a typical metallic conducting agent. When a voltage is applied between the address electrode 122 and the scan electrode Y in order to perform an address discharge, a voltage is not applied to the floating electrodes 117 disposed below the scan electrode Y from the outside, and thus the floating electrodes 117 have a median voltage value. In one embodiment, the voltage of the floating electrodes 117 is determined by each of i) the address electrode 122 and the scan electrode Y, ii) a voltage applied to each of the address electrode 122 and the scan electrode Y, iii) a dielectric constant of materials forming the unit cells S, and iv) a structural position of each of the address electrode 122 and the scan electrode Y and each of the materials forming the unit cells S. In this way, the address electrode 122 and the scan electrode Y, which are conductors, have the same voltage on a surface thereof, and thus an electric field formed in the auxiliary discharge space S2 by the floating electrodes 117 and the address electrode 122 is uniformly distributed.

Herein, a distance between the floating electrode 117 and the sustain electrode X of the adjacent unit cell S is less than a distance between the scan electrode Y and the sustain electrode X. Due to this, a capacitance between the scan electrode Y and the sustain electrode X of the adjacent unit cells S can be increased a little. However, a difference between the voltage of the sustain electrode X and the voltage of the floating electrode 117 is less than a difference between the voltage of the scan electrode Y and the voltage of the floating electrode 117, and thus the ineffective power consumption between the electrodes is not increased.

In addition, the floating electrodes 117 are, in general, formed of a metallic conducting agent, and thus can block light themselves. Therefore, the floating electrodes 117 can act as black stripes. Accordingly, a separate black stripe is not needed, resulting in reduced manufacturing costs and a simple manufacturing process.

According to one embodiment of the present embodiment, formation of a uniform electric field in the auxiliary discharge space S2 is possible, and thus a discharge is stabilized, an increase in ineffective power consumption can be minimized, and the occurrence of crosstalk can be prevented. In addition, the floating electrodes 117 act as black stripes, and thus the effects of a simple manufacturing process can be obtained.

### Second Embodiment

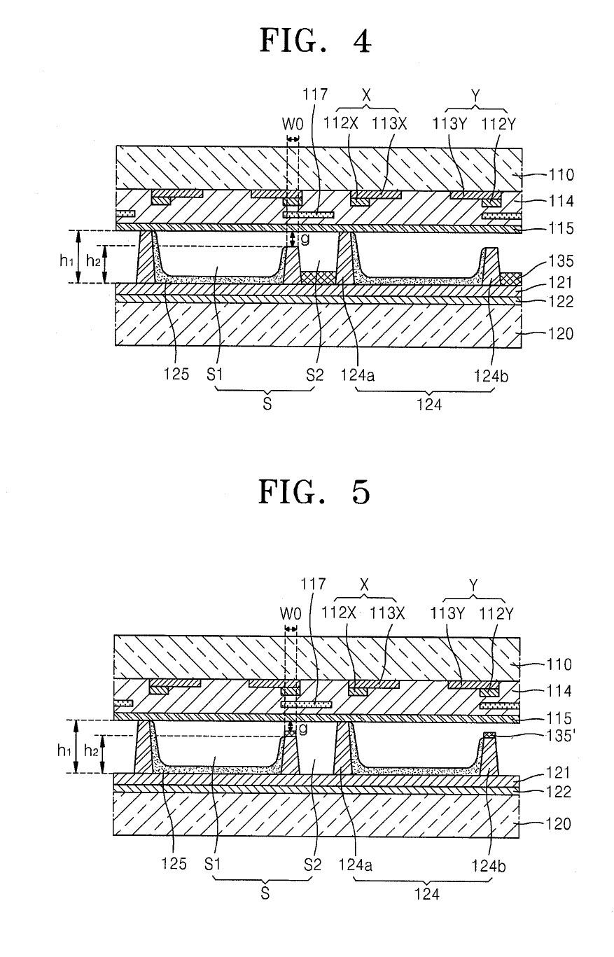

FIG. 4 is a vertical cross-sectional view of a PDP according to a second embodiment of the present invention. Referring to FIG. 4, a front substrate 110 faces a rear substrate 120, and first and second barrier ribs 124a and 124b define a primary discharge space S1 and an auxiliary discharge space S2 between the front substrate 110 and the rear substrate 120. The second barrier rib 124b is formed to have a second height h2 in such a manner that the second barrier rib 124b faces and is separated from a scan electrode Y by a distance of a discharge gap g.

The current embodiment is different from the previous embodiment in that an electron emission material layer 135 is further formed in the auxiliary discharge space S2. The electron emission material layer 135 provides secondary electrons to the auxiliary discharge space S2 so as to activate a discharge in such a manner that an address discharge is focused in the auxiliary discharge space S2. The electron emission material layer 135 may contain any material that induces emission of electrons. For example, the electron emission material layer 135 can contain MgO nano powder, a Sr—CaO thin film, carbon powder, metal powder, MgO paste, ZnO, boron nitride (BN), metal-insulator-semiconductor (MIS) nano powder, oxidized porous silicon (OPS) nano powder, ACE, carbon emitter layer (CEL), or the like. In addition to charged particles generated by ionization as a result of a discharge, secondary electrons can be provided to a discharge space by the electron emission material 135 according to a field emission principle. Therefore, a discharge can be easily initiated and activated.

### Third Embodiment

FIG. 5 is a vertical cross-sectional view of a PDP according to a third embodiment of the present invention. Referring to FIG. 5, a front substrate 110 faces a rear substrate 120, and first and second barrier ribs 124a and 124b define a primary discharge space S1 and an auxiliary discharge space S2 between the front substrate 110 and the rear substrate 120. The second barrier rib 124b is formed to have a second height h2 in such a manner that the second barrier rib 124b faces and is separated from a scan electrode Y by a distance of a discharge gap g.

The current embodiment is different from the previous embodiments in that an electron emission material layer 135′ is further formed on a top surface of the second barrier rib 124b which forms a discharge surface. The electron emission material layer 135′ contains a material that reacts with a discharge field focused in the vicinity of the discharge gap g so as to induce emission of electrons. For example, such a material can be MgO nano powder, a Sr—CaO thin film, carbon powder, metal powder, MgO paste, ZnO, BN, MIS nano powder, OPS nano powder, ACE, CEL, or the like. In addition to charged particles generated by ionization as a result of a discharge, secondary electrons can be provided to a discharge space by the electron emission material 135′ according to a field emission principle. Therefore, a discharge can be easily initiated and activated.

### Fourth Embodiment

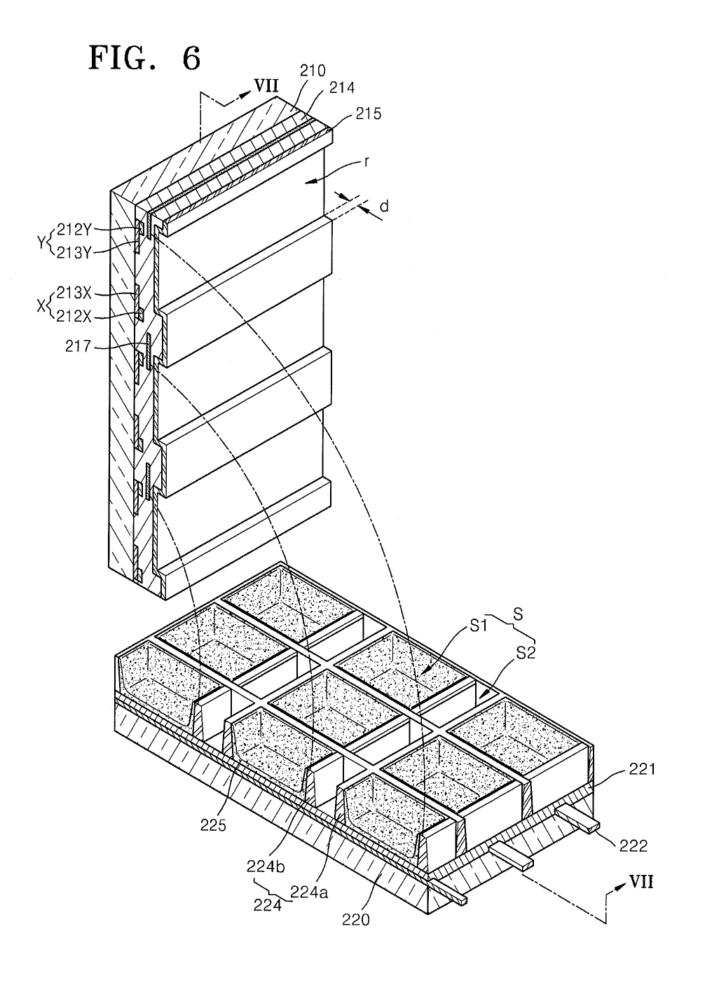

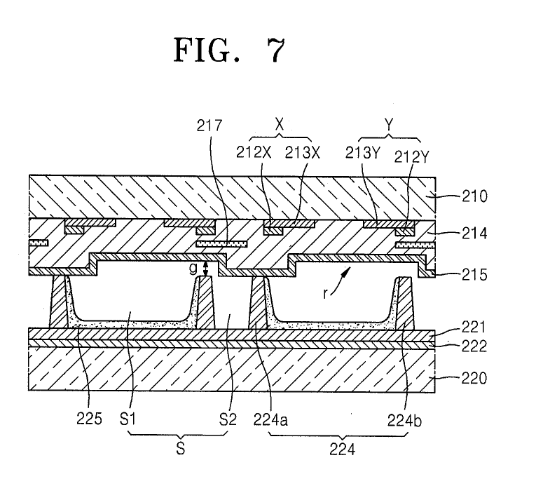

FIG. 6 is an exploded perspective view of a PDP according to a fourth embodiment of the present invention. FIG. 7 is a vertical sectional view taken along line VII-VII in FIG. 6.

Referring to FIGS. 6 and 7, a front substrate 210 faces a rear substrate 220, a first barrier rib 224a defines a plurality of unit cells S between the front substrate 210 and the rear substrate 220, and a second barrier rib 224b divides each of the unit cells S into a primary discharge space S1 and an auxiliary discharge space S2. Each of the unit cells S defined by the first barrier rib 224a includes a pair of a scan electrode Y and a sustain electrode X which perform a mutual display discharge and an address electrode 222 which extends in a direction substantially perpendicular to the direction in which the scan electrode Y extends and causes an address discharge together with the scan electrode Y. The sustain electrode X and the scan electrode Y can include combinations of bus electrodes 212X and 212Y and transparent electrodes 213X and 213Y. The sustain electrode X and the scan electrode Y can be covered with a dielectric layer 214. In addition, a protective layer 215 can be further formed on the dielectric layer 214. The protective layer 215 can include an MgO layer, and induces emission of secondary electrons so as to activate a discharge.

In the meantime, a dielectric layer 221 can be formed on the address electrode 222 on the rear substrate 220. The second barrier rib 224b may correspond to the scan electrode Y. Specifically, the second barrier rib 224b faces the scan electrode Y, and the second barrier rib 224b is separated from the scan electrode Y by a distance of the discharge gap g. Therefore, the second barrier rib 224b can provide a facing discharge surface.

In the PDP according to one embodiment of the present embodiment, floating electrodes 217 are formed in the dielectric layer 214 to form a uniform electric field and minimize an increase in ineffective power consumption. In particular, the floating electrodes 217 are buried in the dielectric layer 214, and may be formed of a general metallic conducting agent. When a voltage is applied between the address electrode 222 and the scan electrode Y in order to perform an address discharge, a voltage is not applied to the floating electrodes 217 disposed below the scan electrode Y from the outside, and thus the floating electrodes 217 have a median voltage value.

In one embodiment, the voltage of the floating electrodes 217 is determined by each of i) the address electrode 222 and the scan electrode Y, ii) a voltage applied to each of the address electrode 222 and the scan electrode Y, iii) a dielectric constant of materials forming the unit cells S, and iv) a structural position of each of the address electrode 222 and the scan electrode Y and each of the materials forming the unit cells S. In this regard, the address electrode 222 and the scan electrode Y, which are conductors, have the same voltage on a surface thereof, and thus an electric field formed in the auxiliary discharge space S2 by the floating electrodes 217 and the address electrode 222 is uniformly distributed.

A distance between the floating electrode 217 and the sustain electrode X of the adjacent unit cell S is less than a distance between the scan electrode Y and the sustain electrode X. Due to this, a capacitance between the scan electrode Y and the sustain electrode X of the adjacent unit cells S can be increased a little. However, a difference between the voltage of the sustain electrode X and the voltage of the floating electrode 217 is less than a difference between the voltage of the scan electrode Y and the voltage of the floating electrode 217, and thus the ineffective power consumption between the scan electrode Y and the sustain electrode X is not increased.

In addition, the floating electrodes 217 are, in general, formed of a metallic conducting agent, and thus can block light themselves. Therefore, the floating electrodes 217 can act as black stripes. Accordingly, a separate black stripe is not needed, resulting in reduced manufacturing costs and a simple manufacturing process.

In the current embodiment, first and second barrier ribs 224a and 224b have substantially the same heights h, and a dielectric layer 214 covering the scan electrode Y has a groove r having a predetermined depth d to form the discharge gap g. The groove r is formed to at least correspond to the scan electrode Y, and, as illustrated in FIG. 7, extends toward the sustain electrode X. Priming particles accumulated in the auxiliary discharge space S2 due to an address effect disperse to the primary discharge space S1 through the discharge gap g and participate in a display discharge.

Although not illustrated, an electron emission material layer can be further formed in the auxiliary discharge space S2. When the electron emission material layer is formed in the auxiliary discharge space S2, the electron emission material layer provides secondary electrons to the auxiliary discharge space S2 and activates a discharge. Therefore, an address discharge can be focused in the auxiliary discharge space S2. The electron emission material layer can contain any material that has a predetermined electron emission characteristic, such as MgO nano powder, a Sr—CaO thin film, carbon powder, metal powder, MgO paste, ZnO, BN, MIS nano powder, OPS nano powder, ACE, or CEL.

Although not illustrated, an electron emission material layer can be formed on the second barrier rib 224b. When the electron emission material layer is formed on the second barrier rib 224b, an address discharge can be easily initiated and activated. The electron emission material layer reacts with a high electric field focused in the vicinity of the discharge gap g and emits secondary electrons. The electron emission material layer can contain any material that has a predetermined electron emission characteristic, such as MgO nano powder, a Sr—CaO thin film, carbon powder, metal powder, MgO paste, ZnO, BN, MIS nano powder, OPS nano powder, ACE, CEL, or the like.

In a PDP according to at least one embodiment of the present invention, a floating electrode is further formed between a scan electrode and an address electrode, whereby formation of a uniform electric field in an auxiliary discharge space is possible, and thus a discharge is stabilized, an increase in ineffective power consumption can be minimized, and the occurrence of crosstalk can be prevented.

In addition, the floating electrode acts as a black stripe, resulting in a simple manufacturing process.

In addition, a discharge interception due to phosphor disposed in the path of a typical address discharge can be prevented and an address voltage margin can be increased. Therefore, a highly efficient display can be realized using a high Xe discharge gas. Thus, the amount of power consumed in a full-HD display having a high resolution can be reduced.

Furthermore, according to at least one embodiment of the present invention, a noise brightness that appears as haze in the vicinity of a display emission and degrades a degree of clarity of an image, such as a discharge light generated when an address discharge occurs or a background light, can be removed, and thus a high quality image having a high contrast effect can be obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP) comprising:
a front substrate and rear substrate that face each other;
a plurality of first barrier ribs disposed between the front substrate and the rear substrate and configured to define a plurality of unit cells;
a plurality of units each comprising a scan electrode and a sustain electrode which are configured to generate a display discharge in the unit cells;
a plurality of second barrier ribs that divide each of the unit cells into a main discharge space and an auxiliary discharge space, wherein the second barrier rib in each unit cell is formed closer to the scan electrode than the sustain electrode;
a plurality of address electrodes configured to perform an address discharge together with the scan electrodes, and extend in a direction substantially perpendicular to the direction of the scan electrodes;
a plurality of floating electrodes disposed between the scan electrodes and the address electrodes; and
a phosphor layer formed in the main discharge space.

2. The PDP of claim 1, further comprising a dielectric layer covering the plurality of units and the floating electrodes.

3. The PDP of claim 1, wherein at least a portion of each of the floating electrodes is formed above at least a portion of the corresponding auxiliary discharge space such that the at least portion of the corresponding auxiliary discharge space and the at least portion of the floating electrode overlap each other.

4. The PDP of claim 1, wherein at least one of the floating electrodes is formed between the scan electrode of a first unit cell and the sustain electrode of a second unit cell, which is adjacent to the first unit cell.

5. The PDP of claim 1, wherein each of the second barrier ribs is disposed to face the corresponding scan electrode with a discharge gap defined therebetween.

6. The PDP of claim 1, wherein the height of the second barrier ribs is less than the height of the first barrier ribs.

7. The PDP of claim 1, wherein the phosphor layer is not formed in the auxiliary discharge space.

8. The PDP of claim 1, further comprising an electron emission material layer formed in the auxiliary discharge space or on a top surface of the second barrier ribs adjacent to the scan electrodes.

9. A plasma display panel (PDP) comprising:
a front substrate and a rear substrate that face each other;
a plurality of first barrier ribs disposed between the front substrate and the rear substrate and configured to define a plurality of unit cells;
a plurality of units each comprising a scan electrode and a sustain electrode which are configured to generate a mutual discharge in the unit cells;
a dielectric layer covering the plurality of units, wherein a groove is formed in a position at least corresponding to the scan electrodes;
a plurality of second barrier ribs that divide each of the unit cells into a main discharge space and an auxiliary discharge space, wherein the second barrier rib in each unit cell is formed closer to the scan electrode than the sustain electrode;
a plurality of address electrodes configured to perform an address discharge together with the scan electrodes, and extend in a direction substantially perpendicular to the direction of the scan electrodes; and
a plurality of floating electrodes disposed between the scan electrodes and the address electrodes.

10. The PDP of claim 9, further comprising a dielectric layer covering the plurality of units and the floating electrodes.

11. The PDP of claim 9, wherein at least a portion of each of the floating electrodes is formed above at least a portion of the corresponding auxiliary discharge space such that the at least portion of the corresponding auxiliary discharge space and the at least portion of the floating electrode overlap each other.

12. The PDP of claim 9, wherein the floating electrode is formed between the scan electrode of a first unit cell and the sustain electrode of a second unit cell, which is adjacent to the first unit cell.

13. The PDP of claim 9, wherein each of the second barrier ribs is disposed to face the corresponding scan electrode with a discharge gap defined therebetween.

14. The PDP of claim 9, wherein the height of the first barrier ribs and the height of the second barrier ribs are substantially the same.

15. The PDP of claim 9, wherein the phosphor layer is not formed in the auxiliary discharge space.

16. The PDP of claim 9, further comprising an electron emission material layer formed in the auxiliary discharge space or on a top surface of the second barrier rib adjacent to the scan electrodes.

17. A plasma display panel (PDP) comprising:
first and second substrates facing each other;
a plurality of first barrier ribs located between the first and second substrates and configured to define a plurality of discharge cells; and
a plurality of second barrier ribs dividing each of the discharge cells into a first sub-discharge cell and a second sub-discharge cell, wherein a phosphor layer is formed in the first sub-discharge cells and is not formed in the second sub-discharge cells.

18. The PDP of claim 17, wherein a passage is defined between each of the first sub-discharge cells and each of the second sub-discharge cells, and wherein residual particles after an address discharge are configured to flow from the second sub-discharge cells into the first sub-discharge cells via the passage.

19. The PDP of claim 17, further comprising:
a plurality of scan electrodes and a plurality of sustain electrodes;
a protective layer contacting at least one of the first and second barrier ribs;
a plurality of floating electrodes located between the scan electrodes and the protective layer, wherein each of the floating electrodes is configured to provide a uniform electrical field in each of the second sub-discharge cells; and
a dielectric layer covering the plurality of scan, sustain and floating electrodes.

20. The PDP of claim 17, further comprising an electron emission material layer formed in each of the second sub-discharge cells on a top surface of the second barrier ribs adjacent to the scan electrodes.
